(19) United States
(12) Patent Application Publication
(10) Pub. No.: US 2025/0226152 A1
(43) Pub. Date: Jul. 10, 2025

(54) WIRE WINDING METHOD FOR FORMING A COMMON MODE CHOKE

(71) Applicant: Cyntec Co., Ltd., Hsinchu (TW)

(72) Inventor: Chia-Cheng Chuang, Hsinchu (TW)

(73) Assignee: Cyntec Co., Ltd., Hsinchu (TW)

(21) Appl. No.: 19/091,784

(22) Filed: Mar. 26, 2025

Related U.S. Application Data
(63) Continuation-in-part of application No. 17/849,735, filed on Jun. 27, 2022.
(60) Provisional application No. 63/247,811, filed on Sep. 24, 2021.

(51) Int. Cl. H01F 41/064

(52) U.S. Cl. CPC H01F 41/064

(57) ABSTRACT

A wire winding method for forming a common mode choke includes winding a first wire and a second wire in parallel for 1 turn, winding the first wire and the second wire to cross each other in a following ¼ turn, winding the first wire and the second wire in parallel for ¾ turn, winding the first wire for ¼ turn, and winding the second wire to cross the first wire, winding the first wire and the second wire in parallel for first ¼ turn, winding the first wire to cross the first wire, and winding the second wire to cross the first wire, winding the first wire and the second wire in parallel for second ¼ turn, winding the first wire to cross the first wire, and winding the second wire for ¼ turn, and winding the first wire and the second wire in parallel for another ¾ turn.

### CROSS REFERENCE TO RELATED APPLICATIONS

This application is a continuation-in-part of U.S. application Ser. No. 17/849,735, filed on Jun. 27, 2022, which claims the benefit of U.S. Provisional Application No. 63/247,811, filed on Sep. 24, 2021. The contents of these applications are incorporated herein by reference.

### BACKGROUND OF THE INVENTION

### 1. Field of the Invention

The present invention is related to a wire winding method, especially to a wire winding method for forming a common mode choke.

### 2. Description of the Related Art

A common mode choke (CMC) is an electrical filter that operates on differential signals to suppress a noise current common to the differential signals while allowing the differential signals to pass, preventing the common mode noise from disrupting data in the differential signals. The noise is referred to as common mode noise. Common mode chokes have found wide applications in various electrical systems in noisy environments. For example, a common mode choke can be placed between a transceiver and a controller area network (CAN) bus in an automotive vehicle to block noise from various devices connected to the CAN bus.

Ideally, a common mode choke includes two wires uniformly wound on a magnetic core to form two windings, so as to provide equal inductances and no parasitic capacitance for equal noise suppression to the differential signals. In practice, the common mode choke is often constructed by stacking one winding (stacking winding) on the other winding (bottom winding) to increase inductances thereof in a limited construction space. However, the magnetic permeability of the magnetic core is frequency-dependent, and as a consequence, the inductances of the stacking winding and the bottom winding vary with the data rates of data transmission, resulting in a degradation of noise immunity, an increase in the electromagnetic interference, and a decrease in mode conversion.

FIG. 1 shows a winding method 100 for forming a common mode choke according to a prior art embodiment. The winding method 100 includes the following steps:
Step S102: from turn 0 to 1, wind a first wire and a second wire in parallel;
Step S104: from turn 1 to 1 1/4, wind the first wire and the second wire to cross each other;
Step S106: from turn 1¼ to 2, wind the first wire and the second wire in parallel;
Step S108: from turn 2 to 2 1/4, wind the first wire, and wind the second wire from a first layer to a second layer to cross the first wire wound at one and a quarter turn;
Step S110: from turn 2¼ to 3, wind the first wire and the second wire in parallel;
Step S112: from turn 3 to 3 1/4, wind the first wire, and wind the second wire from the second layer to the first layer to cross the first wires wound at two and a quarter turn and wound at three and a quarter turn;
Step S114: from turn 3¼ to 4, wind the first wire and the second wire in parallel;
Step S116: from turn 4 to 4 1/4, wind the first wire from the first layer to the second layer to cross the second wire wound at three and a quarter turn, and wind the second wire; and
Step S118: from turn 4¼ to 5, wind the first wire and the second wire in parallel.

By repeating S104-S118 while increasing the turn number by 4 in the following iteration as shown in FIG. 1 until the first wire and the second wire are completely wound, the common mode choke can be formed.

However, there is a fatal flaw in the winding method 100. FIG. 2 shows the schematic diagram of the fatal flaw 200 according to the prior art embodiment. The first wire is wound at four and a quarter turn to cross the second wire wound at three and a quarter turn. In this way, the first wire should be on top of the second wire. The second wire is wound at three and a quarter turn to cross the first wire wound at two and a quarter turn and at three and a quarter turn. The second wire wound at three and a quarter turn presses on top of the first wire at three and a quarter turn, so that the first wire must cross and be close to the second wire. However, the second wire shows a downward slope and cannot lie on the first wire stably, making the first wire at the four and a quarter turn mistakenly slide to the groove between the second wire at the three and a quarter turn and the second wire at the four and a quarter turn (shown as wrong position in FIG. 2) instead of staying at the groove between the first wire at the three and a quarter turn and the second wire at the three and a quarter turn (shown as right position in FIG. 2). Therefore, the first wire at the four and a quarter turn is misplaced.

### SUMMARY OF THE INVENTION

An embodiment provides a wire winding method for forming a common mode choke including winding a first wire and a second wire in parallel for 1 turn, after winding the first wire and the second wire in parallel for 1 turn, winding the first wire and the second wire to cross each other in a following ¼ turn, after winding the first wire and the second wire to cross each other in the following ¼ turn, winding the first wire and the second wire in parallel for ¾ turn, after winding the first wire and the second wire in parallel for ¾ turn, winding the first wire for ¼ turn, and winding the second wire to cross the first wire wound at one and a quarter turn in a following ¼ turn, after winding the first wire for ¼ turn, and winding the second wire to cross the first wire wound at the one and a quarter turn in the following ¼ turn, winding the first wire and the second wire in parallel for first ¼ turn, after winding the first wire and the second wire in parallel for the first ¼ turn, winding the first wire to cross the first wire wound at one and three quarters turn, and winding the second wire to cross the first wire wound at the one and three quarters turn and two and three quarters turn in a following ¼ turn, after winding the first wire to cross the first wire wound at the one and three quarters turn, and winding the second wire to cross the first wire wound at the one and three quarters turn and the two and three quarters turn in the following ¼ turn, winding the first wire and the second wire in parallel for second ¼ turn, after winding the first wire and the second wire in parallel for the second ¼ turn, winding the first wire to cross the first wire wound at two and a quarter turn, and winding the second wire for ¼ turn, and after winding the first wire to cross the first wire wound at the two and a quarter turn, and winding the second wire for ¼ turn, winding the first wire and the second wire in parallel for another ¾ turn.

Another embodiment provides a wire winding method for forming a common mode choke including winding a first wire and a second wire in parallel for 1 turn, after winding the first wire and the second wire in parallel for 1 turn, winding the first wire and the second wire to cross each other in a following ¼ turn, after winding the first wire and the second wire to cross each other in the following ¼ turn, winding the first wire and the second wire in parallel for first ¼ turn, after winding the first wire and the second wire in parallel for the first ¼ turn, winding the first wire for ¼ turn, and winding the second wire to cross the second wire wound at three quarters turn in a following ¼ turn, after winding the first wire for ¼ turn, and winding the second wire to cross the second wire wound at the three quarters turn in the following ¼ turn, winding the first wire and the second wire in parallel for second ¼ turn, after winding the first wire and the second wire in parallel for the second ¼ turn, winding the first wire for ¼ turn, and winding the second wire to cross the first wire and the second wire wound at one and a quarter turn, after winding the first wire for ¼ turn, and winding the second wire to cross the first wire and the second wire wound at the one and a quarter turn, winding the first wire and the second wire in parallel for third ¼ turn, after winding the first wire and the second wire in parallel for the third ¼ turn, winding the first wire for ¼ turn, and winding the second wire to cross the first wire wound at the one and three quarters turn in a following ¼ turn, and after winding the first wire for ¼ turn, and winding the second wire to cross the first wire wound at the one and three quarters turn in the following ¼ turn, winding the first wire and the second wire in parallel for fourth ¼ turn.

Another embodiment provides a wire winding method for forming a common mode choke including winding a first wire and a second wire in parallel for 1 turn, after winding the first wire and the second wire in parallel for 1 turn, winding the first wire for ¼ turn, and winding the second wire to cross the first wire wound at one and a quarter turn and the second wire wound at a quarter turn in a following ¼ turn, after winding the first wire for ¼ turn, and winding the second wire to cross the first wire wound at the one and a quarter turn and the second wire wound at the quarter turn in the following ¼ turn, winding the first wire and the second wire in parallel for first ¾ turn, after winding the first wire and the second wire in parallel for the first ¾ turn, winding the first wire for ¼ turn, and winding the second wire to cross the second wire wound at one and a quarter turn, and after winding the first wire for ¼ turn, and winding the second wire to cross the second wire wound at the one and a quarter turn, winding the first wire and the second wire in parallel for second ¾ turn.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a winding method for forming a common mode choke according to a prior art embodiment.

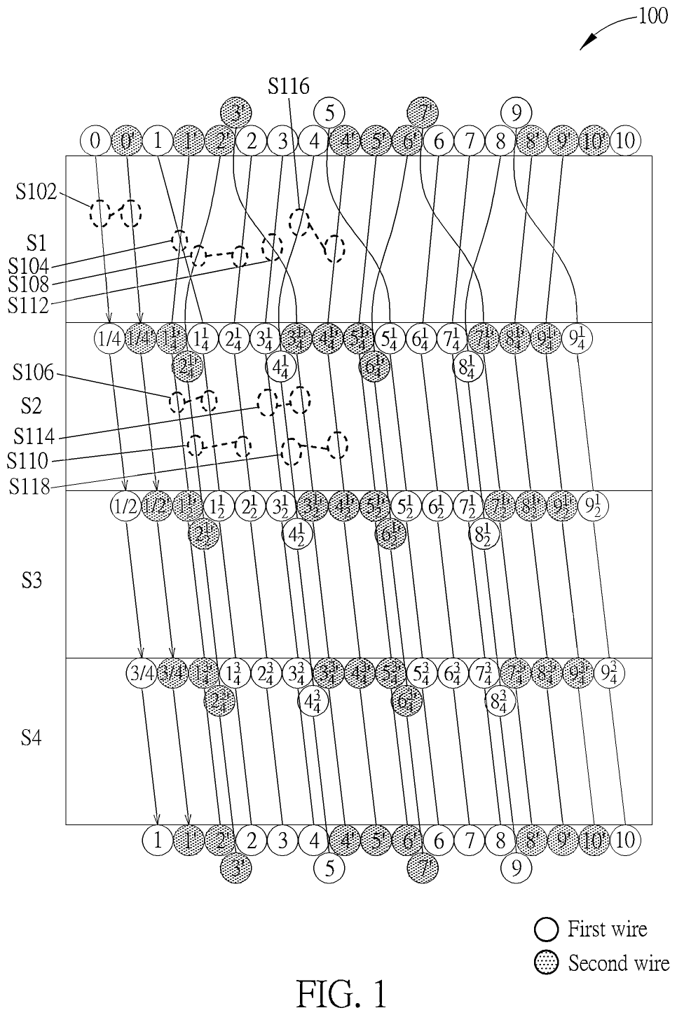

FIG. 2 shows the schematic diagram of the fatal flaw according to the prior art embodiment.

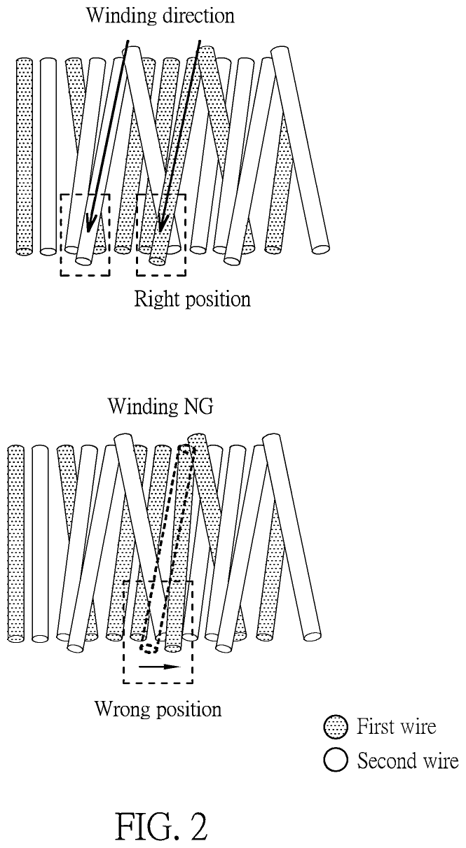

FIG. 3A shows a winding method for forming a common mode choke according to an embodiment of the present invention.

FIG. 3B shows a wire schematic of winding method in FIG. 3A for forming a common mode choke according to an embodiment of the present invention.

FIG. 3C shows a capacitor model of winding method in FIG. 3A for forming a common mode choke according to an embodiment of the present invention.

FIG. 4A shows a winding method for forming a common mode choke according to another embodiment of the present invention.

FIG. 4B shows a wire schematic of winding method in FIG. 4A for forming a common mode choke according to an embodiment of the present invention.

FIG. 4C shows a capacitor model of winding method in FIG. 4A for forming a common mode choke according to an embodiment of the present invention.

FIG. 5A shows a winding method for forming a common mode choke according to another embodiment of the present invention.

FIG. 5B shows a wire schematic of winding method in FIG. 5A for forming a common mode choke according to an embodiment of the present invention.

FIG. 5C shows a capacitor model of winding method in FIG. 5A for forming a common mode choke according to an embodiment of the present invention.

### DETAILED DESCRIPTION

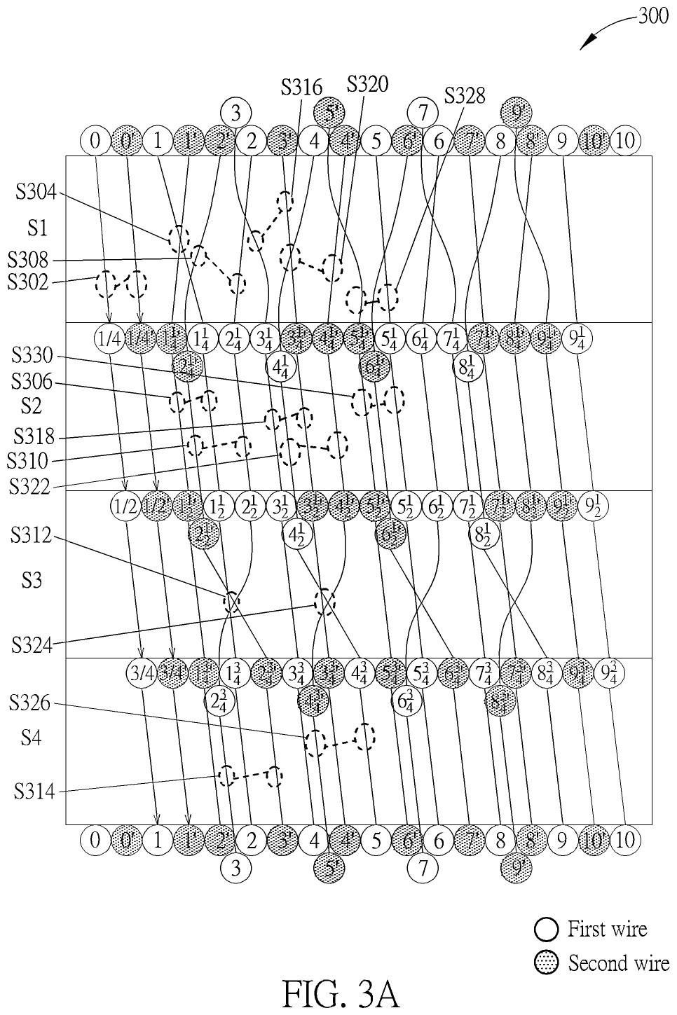

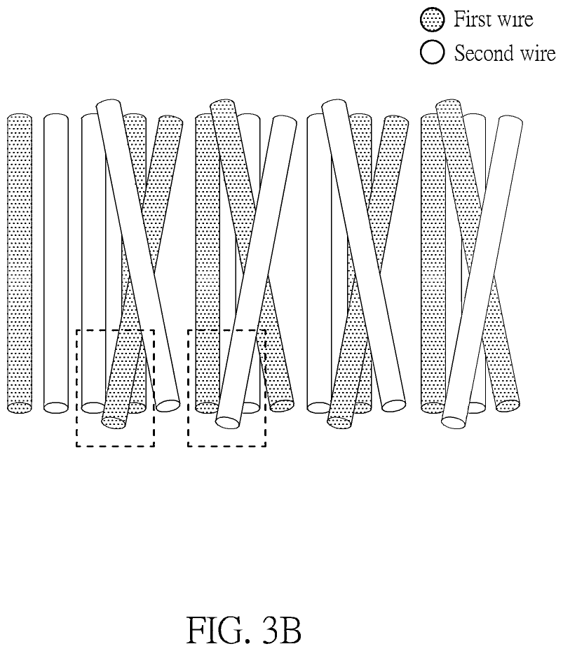

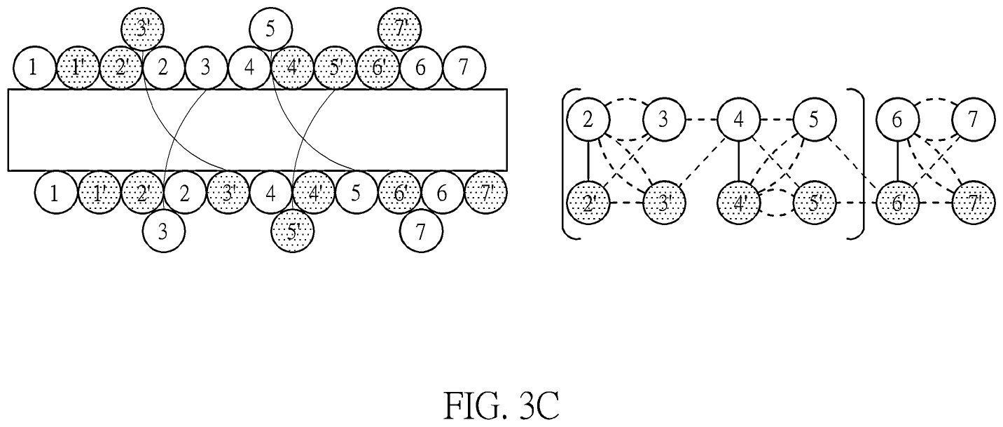

FIG. 3A shows a winding method 300 for forming a common mode choke according to an embodiment of the present invention. The winding method 300 includes the following steps:
Step S302: from turn 0 to 1, wind a first wire and a second wire in parallel;
Step S304: from turn 1 to 1 1/4, wind the first wire and the second wire to cross each other;
Step S306: from turn 1¼ to 2, wind the first wire and the second wire in parallel;
Step S308: from turn 2 to 2 1/4, wind the first wire, and wind the second wire from a first layer to a second layer to cross the first wire wound at one and a quarter turn;
Step S310: from turn 2¼ to 2 1/2, wind the first wire and the second wire in parallel;
Step S312: from turn 2½ to 2 3/4, wind the first wire from the first layer to the second layer to cross the first wire wound at one and three quarters turn, and wind the second wire from the second layer to the first layer to cross the first wire at one and three quarters turn and two and three quarters turn;
Step S314: from turn 2¾ to 3, wind the first wire and the second wire in parallel;
Step S316: from turn 3 to 3 1/4, wind the first wire from the second layer to the first layer to cross the first wire wound at two and a quarter turn, and wind the second wire;
Step S318: from turn 3¼ to 4, wind the first wire and the second wire in parallel;
Step S320: from turn 4 to 4 1/4, wind the first wire from the first layer to the second layer to cross the second wire wound at three and a quarter turn, and wind the second wire;
Step S322: from turn 4¼ to 4 1/2, wind the first wire and the second wire in parallel;
Step S324: from turn 4½ to 4 3/4, wind the first wire from the second layer to the first layer to cross the second wire at three and three quarters turn, and wind the second wire from the first layer to the second layer to cross the first wire wound at four and three quarters turn and the second wire wound at three and three quarters turn;
Step S326: from turn 4¾ to 5, wind the first wire and the second wire in parallel;
Step S328: from turn 5 to 5 1/4, wind the first wire, and wind the second wire from the second layer to the first layer to cross the second wire wound at four and a quarter turn; and
Step S330: from turn 5¼ to 6, wind the first wire and the second wire in parallel.

By repeating S308-S330 while increasing the turn number by 4 in the following iteration as shown in FIG. 3A until the first wire and the second wire are completely wound, the common mode choke can be formed, and the first wire and the second wire can be retained steadily at their correct positions.

FIG. 3B shows a wire schematic of winding method 300 for forming a common mode choke according to an embodiment of the present invention. In FIG. 3B, the first wire and second wire are stable based on the winding method 300. There is no downward slope and the hanging wire can rely on the first wire and the second wire stably. The gap between the first wire and the second wire enables the hanging wire to be steadily positioned. Since there is no unstable wire in FIG. 3A, the misplacement problem in the prior art is resolved.

FIG. 3C shows a capacitor model of winding method 300 for forming a common mode choke according to an embodiment of the present invention. The capacitance of the capacitor model is 0.5*8+2=6, which is 1.5 multiple of the capacitance of the winding method 100. As shown in FIG. 3C, the dashed lines represent half-turn coupling capacitors and the solid lines represent full-turn coupling capacitors. The cycle of the capacitance pattern is 4 turns, and the number of two bias capacitors is equal within the cycle. Therefore, the coupling current effects are canceled between the two bias capacitors.

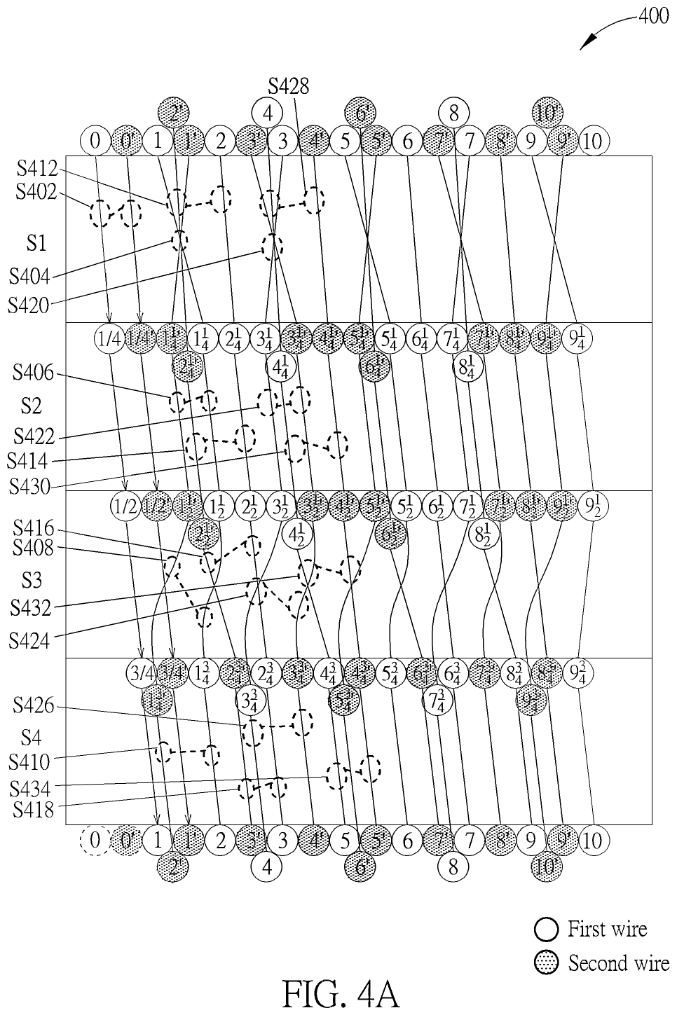

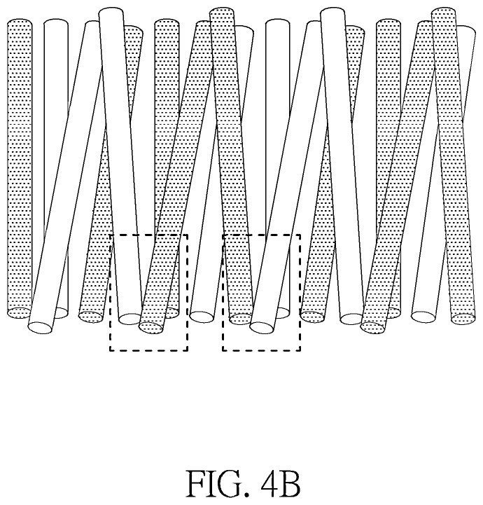

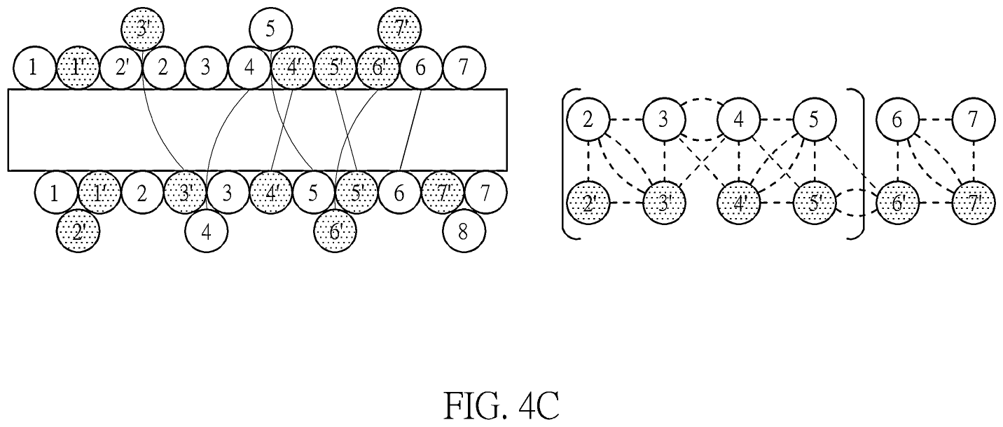

FIG. 4A shows a winding method 400 for forming a common mode choke according to another embodiment of the present invention. The winding method 400 includes the following steps:
Step S402: from turn 0 to 1, wind a first wire and a second wire in parallel;
Step S404: from turn 1 to 1 1/4, wind the first wire and the second wire to cross each other;
Step S406: from turn 1¼ to 1 1/2, wind the first wire and the second wire in parallel;
Step S408: from turn 1½ to 1 3/4, wind the first wire, and wind the second wire from the first layer to the second layer to cross the second wire wound at three quarters turn;
Step S410: from turn 1¾ to 2, wind the first wire and the second wire in parallel;
Step S412: from turn 2 to 2 1/4, wind the first wire, and wind the second wire to cross the first wire wound at one and a quarter turn and the second wire wound at one and a quarter turn;
Step S414: from turn 2¼ to 2 1/2, wind the first wire and the second wire in parallel;
Step S416: from turn 2½ to 2 3/4, wind the first wire, and wind the second wire from the second layer to the first layer to cross the first wire wound at one and three quarters turn;
Step S418: from turn 2¾ to 3, wind the first wire and the second wire in parallel;
Step S420: from turn 3 to 3 1/4, wind the first wire and the second wire to cross each other;
Step S422: from turn 3¼ to 3 1/2, wind the first wire and the second wire in parallel;
Step S424: from turn 3½ to 3 3/4, wind the first wire from the first layer to the second layer to cross the first wire wound at two and three quarters turn, and wind the second wire;
Step S426: from turn 3¾ to 4, wind the first wire and the second wire in parallel;
Step S428: from turn 4 to 4 1/4, wind the first wire to cross the first wire at three and a quarter turn and the second wire wound at three and a quarter turn, and wind the second wire;
Step S430: from turn 4¼ to 4½, wind the first wire and the second wire in parallel;
Step S432: from turn 4½ to 4 3/4, wind the first wire from the second layer to the first layer to cross the second wire wound at three and three quarters turn, and wind the second wire; and
Step S434: from turn 4¾ to 5, wind the first wire and the second wire in parallel.

By repeating S404-S434 while increasing the turn number by 4 in the following iteration as shown in FIG. 4A until the first wire and the second wire are completely wound, the common mode choke can be formed, and the first wire and the second wire can be retained steadily at their correct positions.

FIG. 4B shows a wire schematic of winding method 400 for forming a common mode choke according to an embodiment of the present invention. In FIG. 4B, the first wire and second wire are stable based on the winding method 400. There is no downward slope and the hanging wire can rely on the first wire and the second wire stably. The gap between the first wire and the second wire enables the hanging wire to be steadily positioned. Since there is no unstable wire in FIG. 4A, the misplacement problem in the prior art is resolved.

FIG. 4C shows a capacitor model of winding method 400 for forming a common mode choke according to an embodiment of the present invention. The capacitance of the capacitor model is 0.5*12=6, which is 1.5 multiple of the capacitance of the winding method 100. As shown in FIG. 4C, the dashed lines represent half-turn coupling capacitors and the solid lines represent full-turn coupling capacitors. The cycle of the capacitance pattern is 4 turns, and the number of two bias capacitors is equal within the cycle. Therefore, the coupling current effects are canceled between the two bias capacitors.

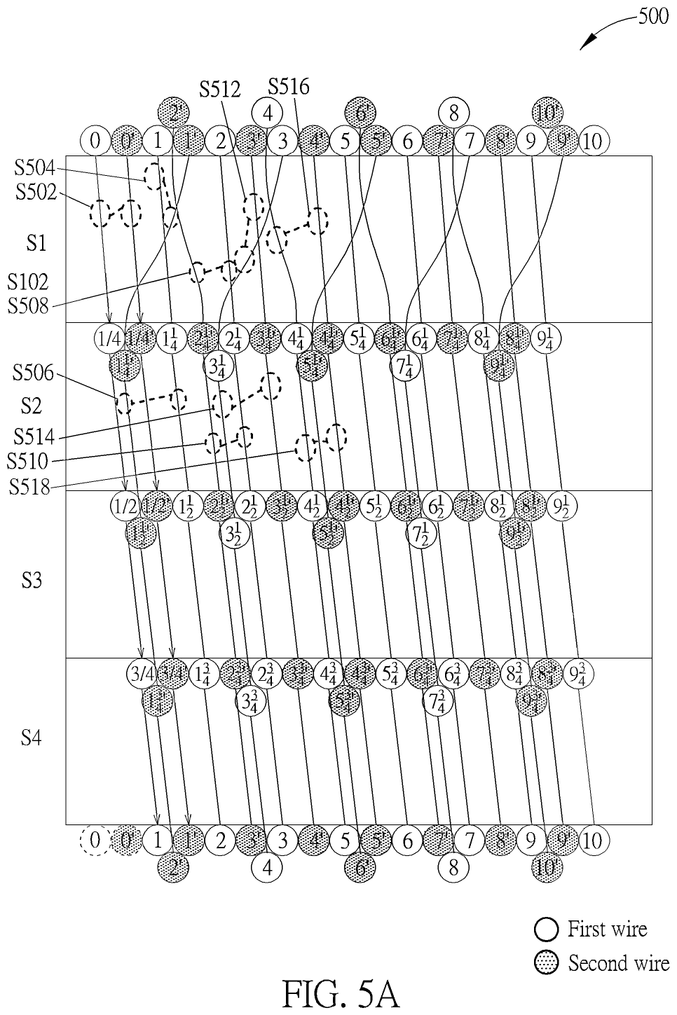

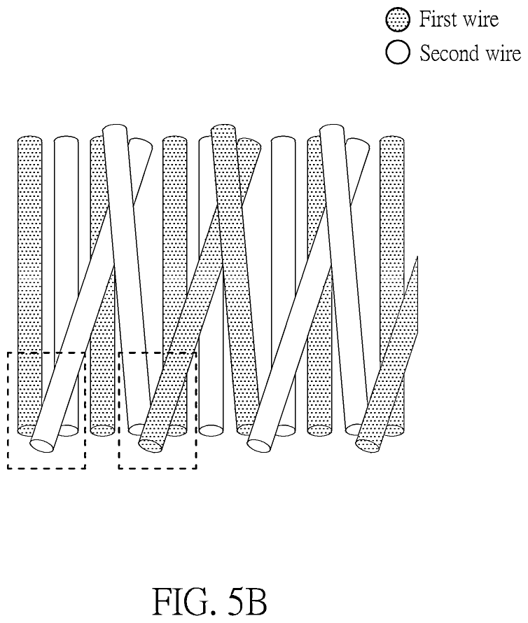

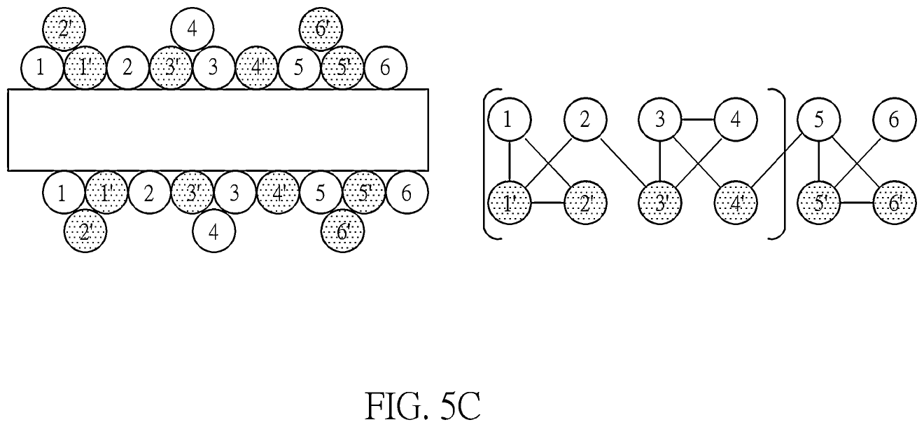

FIG. 5A shows a winding method 500 for forming a common mode choke according to another embodiment of the present invention. The winding method 500 includes the following steps:
Step S502: from turn 0 to 1, wind a first wire and a second wire in parallel;
Step S504: from turn 1 to 1 1/4, wind the first wire, and wind the second wire from the first layer to the second layer to cross the first wire wound at one and a quarter turn and the second wire wound at a quarter turn;
Step S506: from turn 1¼ to 2, wind the first wire and the second wire in parallel;
Step S508: from turn 2 to 2 1/4, wind the first wire, and wind the second wire from the second layer to the first layer to cross the second wire wound at one and a quarter turn;
Step S510: from turn 2¼ to 3, wind the first wire and the second wire in parallel;
Step S512: from turn 3 to 3 1/4, wind the first wire from the first layer to the second layer to cross the first wire wound at two and a quarter turn, and wind the second wire to cross the first wire wound at three and a quarter turn;
Step S514: from turn 3¼ to 4, wind the first wire and the second wire in parallel;
Step S516: from turn 4 to 4 1/4, wind the first wire from the second layer to the first layer to cross the first wire wound at three and a quarter turn, and wind the second wire; and
Step S518: from turn 4¼ to 5, wind the first wire and the second wire in parallel.

By repeating S504-S518 while increasing the turn number by 4 in the following iteration as shown in FIG. 5A until the first wire and the second wire are completely wound, the common mode choke can be formed, and the first wire and the second wire can be retained steadily at their correct positions.

FIG. 5B shows a wire schematic of winding method 500 for forming a common mode choke according to an embodiment of the present invention. In FIG. 5B, the first wire and second wire are stable based on the winding method 500. There is no downward slope and the hanging wire can rely on the first wire and the second wire stably. The gap between the first wire and the second wire enables the hanging wire to be steadily positioned. Since there is no unstable wire in FIG. 5A, the misplacement problem in the prior art is resolved.

FIG. 5C shows a capacitor model of winding method 500 for forming a common mode choke according to an embodiment of the present invention. The capacitance of the capacitor model is 8, which is 2 multiple of the capacitance of the winding method 100. As shown in FIG. 5C, the dashed lines represent half-turn coupling capacitors and the solid lines represent full-turn coupling capacitors. The cycle of the capacitance pattern is 4 turns, and the number of two bias capacitors is equal within the cycle. Therefore, the coupling current effects are canceled between the two bias capacitors.

Based on the three methods 300, 400, 500 proposed in the present invention, the wires winding around the magnetic core are stable, thus the misplacement problem in prior art method 100 is solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wire winding method for forming a common mode choke, comprising:
winding a first wire and a second wire in parallel for 1 turn;
after winding the first wire and the second wire in parallel for 1 turn, winding the first wire and the second wire to cross each other in a following ¼ turn;
after winding the first wire and the second wire to cross each other in the following ¼ turn, winding the first wire and the second wire in parallel for ¾ turn;
after winding the first wire and the second wire in parallel for ¾ turn, winding the first wire for ¼ turn, and winding the second wire to cross the first wire wound at one and a quarter turn in a following ¼ turn;
after winding the first wire for ¼ turn, and winding the second wire to cross the first wire wound at the one and a quarter turn in the following ¼ turn, winding the first wire and the second wire in parallel for first ¼ turn;
after winding the first wire and the second wire in parallel for the first ¼ turn, winding the first wire to cross the first wire wound at one and three quarters turn, and winding the second wire to cross the first wire wound at the one and three quarters turn and two and three quarters turn in a following ¼ turn;
after winding the first wire to cross the first wire wound at the one and three quarters turn, and winding the second wire to cross the first wire wound at the one and three quarters turn and the two and three quarters turn in the following ¼ turn, winding the first wire and the second wire in parallel for second ¼ turn;
after winding the first wire and the second wire in parallel for the second ¼ turn, winding the first wire to cross the first wire wound at two and a quarter turn, and winding the second wire for ¼ turn; and
after winding the first wire to cross the first wire wound at the two and a quarter turn, and winding the second wire for ¼ turn, winding the first wire and the second wire in parallel for another ¾ turn.

2. The method of claim 1, further comprising:
after winding the first wire and the second wire in parallel for another ¾ turn, winding the first wire to cross the second wire wound at three and a quarter turn, and winding the second wire for ¼ turn;
after winding the first wire to cross the second wire wound at the three and a quarter turn, and winding the second wire for ¼ turn, winding the first wire and the second wire in parallel for third ¼ turn;
after winding the first wire and the second wire in parallel for the third ¼ turn, winding the first wire to cross the second wire wound at three and three quarters turn, and winding the second wire to cross the first wire wound at four and three quarters turn and cross the second wire wound at the three and three quarters turn;
after winding the first wire to cross the second wire wound at the three and three quarters turn, and winding the second wire to cross the first wire wound at the four and three quarters turn and cross the second wire wound at the three and three quarters turn, winding the first wire and the second wire in parallel for fourth ¼ turn;
after winding the first wire and the second wire in parallel for the fourth ¼ turn, winding the first wire for ¼ turn, and winding the second wire to cross the second wire wound at four and a quarter turn;
after winding the first wire for ¼ turn, and winding the second wire to cross the second wire wound at the four and a quarter turn, winding the first wire and the second wire in parallel for ¾ turn.

3. The method of claim 2, wherein the first wire is wound from a first layer to a second layer at four and a quarter turn, and from the second layer to the first layer at four and three quarters turn, and the second wire is wound from the first layer to the second layer at the four and three quarters turn, and from the second layer to the first layer at five and a quarter turn.

4. The method of claim 1, wherein the first wire is wound from a first layer to a second layer at the two and three quarters turn, and from the second layer to the first layer at three and a quarter turn, and the second wire is wound from the first layer to the second layer at the two and a quarter turn, and from the second layer to the first layer at the two and three quarters turn.

5. The method of claim 1, wherein the first wire and the second wire are wound around a magnetic core.

6. A wire winding method for forming a common mode choke, comprising:
winding a first wire and a second wire in parallel for 1 turn;
after winding the first wire and the second wire in parallel for 1 turn, winding the first wire and the second wire to cross each other in a following ¼ turn;
after winding the first wire and the second wire to cross each other in the following ¼ turn, winding the first wire and the second wire in parallel for first ¼ turn;
after winding the first wire and the second wire in parallel for the first ¼ turn, winding the first wire for ¼ turn, and winding the second wire to cross the second wire wound at three quarters turn in a following ¼ turn;
after winding the first wire for ¼ turn, and winding the second wire to cross the second wire wound at the three quarters turn in the following ¼ turn, winding the first wire and the second wire in parallel for second ¼ turn;
after winding the first wire and the second wire in parallel for the second ¼ turn, winding the first wire for ¼ turn, and winding the second wire to cross the first wire and the second wire wound at one and a quarter turn;
after winding the first wire for ¼ turn, and winding the second wire to cross the first wire and the second wire wound at the one and a quarter turn, winding the first wire and the second wire in parallel for third ¼ turn;
after winding the first wire and the second wire in parallel for the third ¼ turn, winding the first wire for ¼ turn, and winding the second wire to cross the first wire wound at the one and three quarters turn in a following ¼ turn; and
after winding the first wire for ¼ turn, and winding the second wire to cross the first wire wound at the one and three quarters turn in the following ¼ turn, winding the first wire and the second wire in parallel for fourth ¼ turn.

7. The method of claim 6, further comprising:
after winding the first wire and the second wire in parallel for the fourth ¼ turn, winding the first wire and the second wire to cross each other in a following ¼ turn;
after winding the first wire and the second wire to cross each other in the following ¼ turn, winding the first wire and the second wire in parallel for fifth ¼ turn;
after winding the first wire and the second wire in parallel for the fifth ¼ turn, winding the first wire to cross the first wire wound at two and three quarters turn, and winding the second wire for ¼ turn;
after winding the first wire to cross the first wire wound at the two and three quarters turn, and winding the second wire for ¼ turn, winding the first wire and the second wire in parallel for sixth ¼ turn;
after winding the first wire and the second wire in parallel for the sixth ¼ turn, winding the first wire to cross the first wire and the second wire wound at three and a quarter turn, and winding the second wire for ¼ turn;
after winding the first wire to cross the first wire and the second wire wound at the three and a quarter turn, and winding the second wire for ¼ turn, winding the first wire and the second wire in parallel for seventh ¼ turn;
after winding the first wire and the second wire in parallel for the seventh ¼ turn, winding the first wire to cross the second wire wound at the three and three quarters turn for ¼ turn, and winding the second wire for ¼ turn; and
after winding the first wire to cross the second wire wound at the three and three quarters turn for ¼ turn, and winding the second wire for ¼ turn, winding the first wire and the second wire in parallel for fourth ¼ turn.

8. The method of claim 7, wherein the first wire is wound from a first layer to a second layer at the three and three quarters turn, and from the second layer to the first layer at four and three quarters turn.

9. The method of claim 6, wherein the second wire is wound from the first layer to the second layer at the one and three quarters turn, and from the second layer to the first layer at the two and three quarters turn.

10. The method of claim 6, wherein the two wires are wound around a magnetic core.

11. A wire winding method for forming a common mode choke, comprising:
winding a first wire and a second wire in parallel for 1 turn;
after winding the first wire and the second wire in parallel for 1 turn, winding the first wire for ¼ turn, and winding the second wire to cross the first wire wound at one and a quarter turn and the second wire wound at a quarter turn in a following ¼ turn;
after winding the first wire for ¼ turn, and winding the second wire to cross the first wire wound at the one and a quarter turn and the second wire wound at the quarter turn in the following ¼ turn, winding the first wire and the second wire in parallel for first ¾ turn;
after winding the first wire and the second wire in parallel for the first ¾ turn, winding the first wire for ¼ turn, and winding the second wire to cross the second wire wound at one and a quarter turn; and
after winding the first wire for ¼ turn, and winding the second wire to cross the second wire wound at the one and a quarter turn, winding the first wire and the second wire in parallel for second ¾ turn.

12. The method of claim 11, further comprising:
after winding the first wire and the second wire in parallel for the second ¾ turn, winding the first wire to cross the first wire wound at two and a quarter turn, and winding the second wire to cross the first wire wound at three and a quarter turn;
after winding the first wire to cross the first wire wound at the two and a quarter turn, and winding the second wire to cross the first wire wound at the three and a quarter turn, winding the first wire and the second wire in parallel for third ¾ turn;
after winding the first wire and the second wire in parallel for the third ¾ turn, winding the first wire to cross the first wire wound at three and a quarter turn, and winding the second wire for ¼ turn; and
after winding the first wire to cross the first wire wound at the three and a quarter turn, and winding the second wire for ¼ turn, winding the first wire and the second wire in parallel for fourth ¾ turn.

13. The method of claim 12, wherein the first wire is wound from a first layer to a second layer at the three and a quarter turn, and from the second layer to the first layer at four and a quarter turn.

14. The method of claim 11, wherein the second wire is wound from the first layer to the second layer at the one and a quarter turn, and from the second layer to the first layer at two and a quarter turn.

15. The method of claim 11, wherein the two wires are wound around a magnetic core.
